(19) United States
(12) Patent Application Publication
(10) Pub. No.: US 2009/0000500 A1
(43) Pub. Date: Jan. 1, 2009

(54) PRINTING PRESS CENTRAL CONTROL CONSOLE

(75) Inventor: Wolfgang MAYER, Augsburg (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/144,433

(22) Filed: Jun. 23, 2008

(30) Foreign Application Priority Data
Jun. 23, 2007 (DE) 10 2007 028 970.9

(51) Int. Cl. B41F 31/02

(52) U.S. Cl. 101/365

(57) ABSTRACT

A printing press central control console of a web-fed printing press is disclosed. An operator console includes several operating elements for ink-zone adjusting elements of inking couples. Two groups of operating elements are positioned on one side of the row of operating elements for the ink-zone adjusting elements. A further group of operating elements is positioned next to the first group of operating elements at the distance of the widest newspaper printing format. The three groups of operating elements extend perpendicular to the row of operating elements for the ink-zone adjusting elements. The total number of operating elements in the row is designed for a commercial web printing format, and the number of operating elements in the row, which is arranged between two of the groups of operating elements, is designed for a newspaper printing format, which features a fraction of the axial width of the commercial web printing format.

This application claims the priority of German Patent Document No. 10 2007 028 970.9, filed Jun. 23, 2007, the disclosure of which is expressly incorporated by reference herein.

### BACKGROUND AND SUMMARY OF THE INVENTION

The invention relates to a printing press central control console of a web-fed printing press.

In the case of web-fed printing presses, a differentiation is made in principle between newspaper printing presses and commercial web printing presses. Newspaper printing presses are used to print a newspaper printing product in the newspaper printing format and commercial web printing presses are used to print a commercial web printing product in the commercial web format. The newspaper printing format typically features a fraction of the axial width of the commercial web printing format.

An increasing demand has been noted in printing plants for variable format web-fed printing presses. Therefore, particularly web-fed printing presses that can print both newspaper printing products as well as commercial web printing products are desired. Until now printing press central control consoles known from practice have been designed either for newspaper printing or for commercial web printing. As a result, a need exists for a printing press central control console, which is suitable for newspaper printing, on the one hand, and commercial web printing, on the other.

Starting herefrom, the present invention is based on the objective of creating a novel printing press central control console.

According to the invention, two groups of operating elements are positioned on one side of the row of operating elements for the ink-zone adjusting elements, namely a first group of operating elements for inputting print page-specific commands and a second group of operating elements for inputting printing press-specific commands, wherein a further group of operating elements is positioned next to the first group of operating elements at the distance of the widest newspaper printing format, namely a third group of operating elements for inputting print page-specific commands, wherein the first group and the second group and the third group of operating elements extend perpendicular to the row of operating elements for the ink-zone adjusting elements, wherein the total number of operating elements in the row of operating elements for the ink-zone adjusting elements is designed for a commercial web printing format, and wherein the number of operating elements in the row of operating elements for the ink-zone adjusting elements, which is arranged between the two groups of operating elements for inputting print page-specific commands, is designed for a newspaper printing format, which features a fraction of the axial width of the commercial web printing format.

The inventive printing press central control console is suitable both for newspaper printing as well as for commercial web printing. The inventive printing press central control console is thus in a manner of speaking a hybrid central control console. Because of the corresponding arrangement of the operating elements on the operator console of the printing press central control console, commands can be input both for newspaper printing products in the newspaper printing format as well as for commercial web printing products in the commercial web printing format.

Preferred developments of the invention are yielded from the following description. Without being limited hereto, one exemplary embodiment of the invention is explained in greater detail on the basis of the drawings.

### BRIEF DESCRIPTION OF THE DRAWINGS

FIG. 1 is a perspective view of an inventive printing press central control console;

FIG. 2 is a top view of the printing press central control console from FIG. 1 with a newspaper printing product; and

FIG. 3 is another top view of the printing press central control console from FIG. 1 with a commercial web printing product.

### DETAILED DESCRIPTION OF THE DRAWINGS

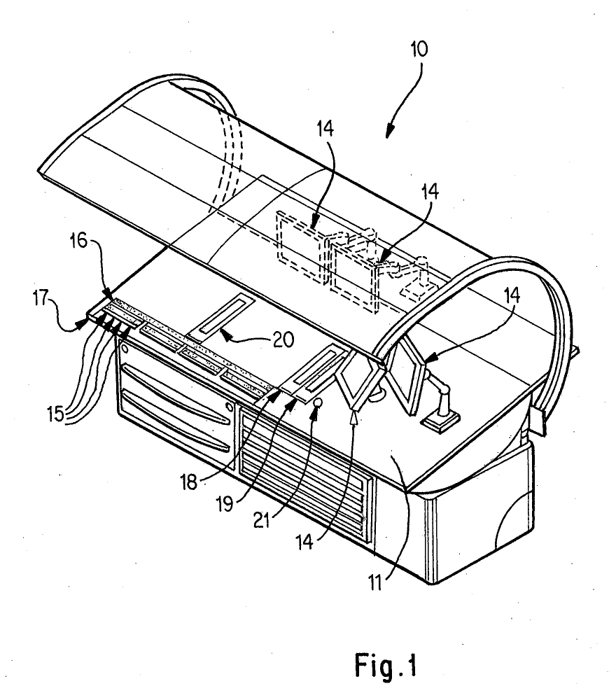

FIG. 1 shows a perspective view of an inventive printing press central control console 10 for a web-fed printing press, namely for a web-fed printing press that can print both newspaper printing products in the newspaper printing format as well as commercial web printing products in the commercial web printing format.

The newspaper printing format of newspaper printing products typically features half the axial width as compared to the commercial web printing format of commercial web printing products. Thus, a newspaper printing format is characterized for example by an axial width of up to 686 mm and by a height of up to 536 mm. A commercial web printing format is characterized for example by an axial width of up to 1372 mm and by a height of up to 1092 mm.

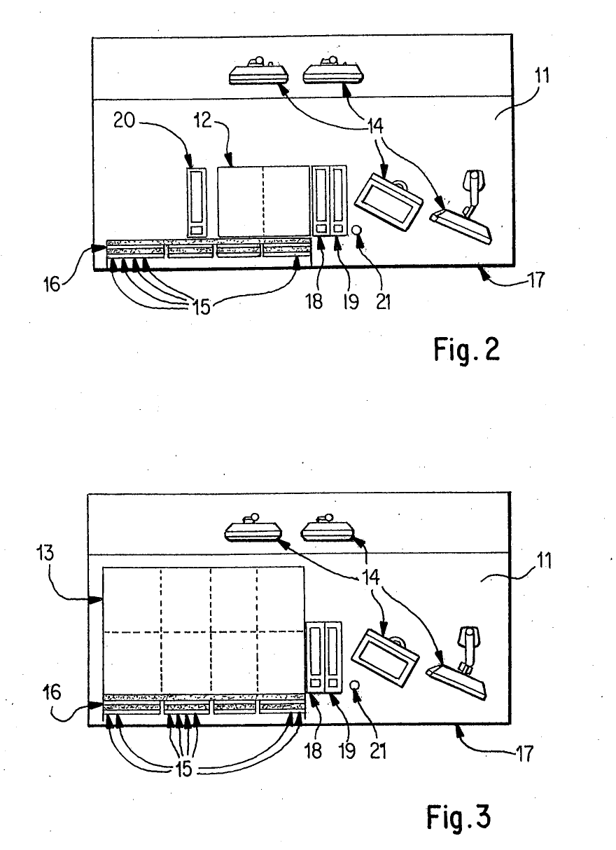

The printing press central control console 10 is comprised of an operator console 11, wherein FIGS. 2 and 3 show top views of the operator console 11. In FIG. 2, a newspaper printing product 12 in the newspaper printing format is deposited on the operator console 11 and in FIG. 3 a commercial web printing product 13 in the commercial web printing format is deposited on the operator console 11.

According to FIGS. 1 through 3, a total of four monitors 14, for example, are fastened on the operator console 11 in the depicted exemplary embodiment, whereby the monitors 14 are used to display process parameters and/or input process parameters for the printing presses. One monitor 14 is embodied thereby as a touch screen or an operating screen.

The operator console 11 of the inventive printing press central control console 10 has at its disposal several operating elements 15 for ink-zone adjusting elements of inking couples of the web-fed printing press. Every ink zone of an inking couple and therefore every ink zone of a printing couple of the web-fed printing press is allocated a corresponding operating element 15, whereby the operating elements 15 for the ink-zone adjusting elements are positioned on the operator console 11 next to one another in a row 16, and whereby this row 16 of operating elements 15 for the ink-zone adjusting elements runs adjacent and parallel to a front edge 17 of the operator console 11.

In addition to this row 16 of operating elements 15 for the ink-zone adjusting elements, the operator console 11 of the inventive printing press central control console 10 is comprised of additional operating elements. Thus, two groups of operating elements are positioned on one side of the row 16 of operating elements 15 for the ink-zone adjusting elements, preferably on the right side of the row 16, namely a first group 18 of operating elements for inputting print page-specific commands and a second group 19 of operating elements for inputting printing press-specific commands. The first group 18 and the second group 19 of operating elements are, as already mentioned, arranged on the right next to the row 16 of operating elements 15 for the ink-zone adjusting elements, whereby the first group 18 and the second group 19 of operating elements extend in a column-like manner perpendicular to the row 16 of operating elements 15 for the ink-zone adjusting elements.

The first group 18 of operating elements for inputting print page-specific commands is arranged directly to the right next to the row 16 of operating elements 15 for the ink-zone adjusting elements.

The second group 19 of operating elements for inputting printing press-specific commands is arranged directly to the right next to the first group 18 of operating elements for inputting print page-specific commands.

Furthermore, the operator console 11 of the inventive printing press central control console 10 is comprised of a third group 20 of operating elements for inputting print page-specific commands, whereby the third group 20 is positioned to the left of the first group 18 of operating elements for inputting print page-specific commands at the distance of the widest newspaper printing format, in the depicted exemplary embodiment approximately in the center of the row 16 of operating elements 15 for the ink-zone adjusting elements, and whereby this third group 20 of operating elements also extends in a column-like manner perpendicular to the row 16 of operating elements 15 for the ink-zone adjusting elements.

The total number of operating elements 15 in the row 16 of operating elements for the ink-zone adjusting elements is designed for a commercial web printing format. The number of operating elements 15 in the row 16 of operating elements for the ink-zone adjusting elements, which extend between the first group 18 and the third group 20 of operating elements for inputting print page-specific commands, is designed for a newspaper printing format, whereby, as already mentioned, the newspaper printing format typically features approximately half the axial width of the commercial web printing format. The third group 20 of operating elements for inputting print page-specific commands is arranged directly to the left next to the operating elements 15 of the row 16 of operating elements for the ink-zone adjusting elements, which are allocated to the newspaper printing format.

As FIG. 2 shows, when a newspaper printing product 12 is deposited on the operator console 11 of the inventive printing press central control console 10, the first group 18 of operating elements for inputting print page-specific commands, the second group 19 of operating elements for inputting printing press-specific commands, the third group 20 of operating elements for inputting print page-specific commands as well as the row 16 of operating elements 15 for the ink-zone adjusting elements is freely accessible.

On the other hand, when, according to FIG. 3, a commercial web printing product 13 is deposited on the operator console 11 of the inventive printing press central control console, the third group 20 of operating elements is concealed by the commercial web printing product so that only the first group 18 and the second group 19 of operating elements as well as the row 16 of operating elements 15 for the ink-zone adjusting elements are freely accessible.

The operator console 11 of the inventive printing press central control console is also comprised of a switch-over device 21, in order to transfer the printing press central control console 10 between an operating state for newspaper printing and an operating state for commercial web printing. In the operating state for newspaper printing, the first group 18, the second group 19, the third group 20 as well as those operating elements from the row 16 of operating elements that are arranged between the first group 18 and the third group 20 and allocated to the newspaper printing format are active. In the operating state for commercial web printing, on the other hand, the third group 20 of operating elements is inactive so that exclusively the first group 18, the second group 19 as well as the row 16 of operating elements 15 are active, and namely all operating elements 15 of the row 16 that are allocated to commercial web printing.

The switch-over device 21 in the depicted exemplary embodiment is embodied as a button and is integrated into the operator console. Alternatively, the switch-over device can also be provided by a monitor 14 embodied as a touch screen or by a sensor, which detects the format deposited on the operator console.

Included among the operating elements of the second group 19 for inputting printing press-specific commands are in particular operating elements for inputting crawl commands for the printing press. Included among the operating elements of the groups 18 and 20 for inputting print page-specific commands are in particular operating elements for inputting commands for dampening solution metering devices of dampening units and for inputting commands for an ink duct roller of the inking couple.

When the number of shutters of the dampening units is greater than the number of operating elements that are being kept in readiness for the commercial web printing format for influencing the shutters in the first group 18 of operating elements, the operator console 11 of the inventive printing press central control console can include a further switch-over device (not shown) in order to make the operating elements 15 of the row 16 for the ink-zone adjusting elements usable for inputting commands for the shutters of the dampening units.

As described above, the inventive printing press central control console 10 is suitable both for a newspaper printing format as well as for a larger commercial web printing format. This is accordingly a hybrid central control console.

Reference is made to the fact that the depicted exemplary embodiment is designed for right-handers. A mirrored arrangement of the groups 18, 19 and 20 of operating elements is also conceivable for left-handers. In this case, the first group 18 and the second group 19 of operating elements would then be arranged to the left next to the row 16 of operating elements 15 for the ink-zone adjusting elements, wherein the first group 18 of operating elements for inputting print page-specific commands would be arranged directly to the left next to the row 16 of operating elements 15 for the ink-zone adjusting elements and the second group 19 of operating elements for inputting printing press-specific commands would be arranged directly to the left next to the first group 18 of operating elements for inputting print page-specific commands. The third group 20 of operating elements would then be positioned to the right next to the first group 18 of operating elements at the distance of the widest newspaper printing format. In the same way, the switch-over device 21 as well as the monitors 14 would be positioned on the operator console 11 in a mirrored manner as compared to the depicted exemplary embodiment.

List of reference numerals:
10 Printing press central control console
11 Operator console
12 Newspaper printing product
13 Commercial web printing product
14 Monitor
15 Operating element
16 Row
17 Front edge
18 First group
19 Second group
20 Third group
21 Switch-over device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing press central control console of a web-fed printing press, with an operator console, wherein the operator console features several operating elements for ink-zone adjusting elements of inking couples, which are positioned on the operator console next to one another in a row running parallel to a front edge of the operator console, and wherein two groups of operating elements are positioned on one side of the row of operating elements for the ink-zone adjusting elements, namely a first group of operating elements for inputting print page-specific commands and a second group of operating elements for inputting printing press-specific commands, wherein a further group of operating elements is positioned next to the first group of operating elements at a distance of a widest newspaper printing format, namely a third group of operating elements for inputting print page-specific commands, wherein the first group and the second group and the third group of operating elements extend perpendicular to the row of operating elements for the ink-zone adjusting elements, wherein a total number of operating elements in the row of operating elements for the ink-zone adjusting elements is designed for a commercial web printing format, and wherein a number of operating elements in the row of operating elements for the ink-zone adjusting elements, which is arranged between the first and third groups of operating elements for inputting print page-specific commands, is designed for a newspaper printing format, which features a fraction of an axial width of the commercial web printing format.

2. The printing press central control console according to claim 1, wherein the first group and the second group of operating elements are arranged to a right or a left next to the row of operating elements for the ink-zone adjusting elements.

3. The printing press central control console according to claim 2, wherein the first group of operating elements for inputting print page-specific commands is arranged directly to the right or the left next to the row of operating elements for the ink-zone adjusting elements, and wherein the second group of operating elements for inputting printing press-specific commands is arranged directly to the right or the left next to the first group of operating elements for inputting print page-specific commands.

4. The printing press central control console according to claim 1, wherein the third group of operating elements for inputting printing page-specific commands is arranged directly to a left or a right next to the operating elements of the row of operating elements for the ink-zone adjusting elements which are designed for the newspaper printing format.

5. The printing press central control console according to claim 1, wherein when a newspaper printing product is deposited on the operator console, the first group and the second group and the third group of operating elements as well as the row of operating elements for the ink-zone adjusting elements are accessible.

6. The printing press central control console according to claim 1, wherein when a commercial web printing product is deposited on the operator console, the third group of operating elements is concealed by the commercial web printing product and therefore only the first group and the second group of operating elements as well as the row of operating elements for the ink-zone adjusting elements are accessible.

7. The printing press central control console according to claim 1, wherein a switch-over device in order to transfer the printing press central control console between an operating state for newspaper printing, in which the first group and the second group and the third group of operating elements as well as the operating elements from the row of operating elements for the ink-zone adjusting elements that are arranged between the first group and the third group are active, and an operating state for commercial web printing, in which the first group and the second group of operating elements as well as the row of operating elements for the ink-zone adjusting elements are active.

8. The printing press central control console according to claim 7, wherein in the operating state for commercial web printing, the third group of operating elements for inputting print page-specific commands is inactive.

9. The printing press central control console according to claim 7, wherein the switch-over device is embodied as a button integrated into the operator console or is made available by a monitor embodied as a touch screen or by a sensor that detects a format deposited on the operator console.

10. An operator console of a web-fed printing press, comprising:
a row of operating elements for ink-zone adjusting elements of inking couples;
a first group of operating elements for inputting print page-specific commands;
a second group of operating elements for inputting printing press-specific commands; and
a third group of operating elements for inputting print page-specific commands;
wherein the first group, the second group, and the third group of operating elements extend perpendicular to the row of operating elements for ink-zone adjusting elements;
wherein a total number of operating elements in the row of operating elements for ink-zone adjusting elements is adapted for a commercial web printing format;
and wherein a number of operating elements in the row of operating elements for ink-zone adjusting elements, which are arranged between the first and third groups of operating elements, is designed for a newspaper printing format which has an axial width that is a fraction of an axial width of the commercial web printing format.
